(19) United States
(12) Patent Application Publication
(10) Pub. No.: US 2025/0048137 A1
(43) Pub. Date: Feb. 6, 2025

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Qin MU, Beijing (CN)

(21) Appl. No.: 18/836,129

(22) PCT Filed: Feb. 17, 2022
(86) PCT No.: PCT/CN2022/076701

§ 371 Date: Aug. 6, 2024

(51) Int. Cl. H04W 24/02; H04L 25/02; H04W 16/18; H04W 72/1273; H04W 72/51

(52) U.S. Cl. CPC H04W 24/02; H04L 25/0224; H04W 16/18; H04W 72/1273; H04W 72/51

(57) ABSTRACT

An information processing method is performed by a base station and includes: sending configuration information, wherein the configuration information includes Resource Block (RB) indication information indicating a number of RBs with same precoding for a User Equipment (UE), and the number of RBs is used for the UE to determine an Artificial Intelligence (AI) model to perform channel estimation.

### CROSS REFERENCE TO RELATED APPLICATION

The present application is a U.S. National Stage of International Application No. PCT/CN2022/076701, filed on Feb. 17, 2022, the content of which is incorporated herein by reference in its entirety.

### TECHNICAL FIELD

The present disclosure relates to, but is not limited to, the field of communication technologies, and in particular to an information processing method and apparatus, a communication device and a storage medium.

### BACKGROUND

In traditional channel estimation, the channel estimation is jointly performed for Demodulation Reference Signals (DMRS) in multiple Resource Blocks (RBs). When DMRSs of different numbers of RBs are adopted for performing channel estimation jointly, if input data dimensions for the channel estimation are different, for example, DMRSs of different numbers of RBs are input to an Artificial Intelligence (AI) model in an AI method, the required AI model is also different.

In the New Radio (NR), the concept of Physical Resource Block bundling (PRB bundling) configuration is introduced. The PRB bundling configuration may be as follows: it is specified that a plurality of consecutive RBs in a frequency domain use the same precoding rule. If the PRB bundling configuration is introduced, dimensions of DMRSs of different numbers of RBs do not match a dimension of input data of a single AI model, this may cause the AI method to fail and its AI model to be unable to adapt to the changes in channel estimation of DMRSs of different numbers of RBs after the PRB bundling configuration.

### SUMMARY

Embodiments of the present disclosure disclose an information processing method and apparatus, a communication device and a storage medium.

According to a first aspect of the present disclosure, there is provided an information processing method. The method is performed by a base station and includes:
sending configuration information, wherein the configuration information includes RB indication information indicating the number of RBs with the same precoding for the UE, and the number of RBs is used for the UE to determine an AI model to perform channel estimation.

According to a second aspect of the present disclosure, there is provided an information processing method. The method is performed by a UE and includes:
receiving configuration information, wherein the configuration information includes RB indication information indicating the number of RBs with the same precoding for the UE; and
based on the number of RBs, determining an AI model to perform channel estimation.

According to a third aspect of the present disclosure, there is provided an information processing apparatus. The apparatus is applied to a base station and includes:
a first sending module configured to send configuration information, wherein the configuration information includes RB indication information indicating the number of RBs with the same precoding for the UE, and the number of RBs is used for the UE to determine an AI model to perform channel estimation.

According to a fourth aspect of the present disclosure, there is provided a processing apparatus. The apparatus is applied to a UE and includes:
a second receiving module configured to receive configuration information, wherein the configuration information includes Resource Block (RB) indication information indicating the number of RBs with the same precoding of the UE; and
a second processing module configured to determine an AI model to perform channel estimation based on the number of RBs.

According to a fifth aspect of the present disclosure, there is provided a communication device. The communication device includes:
a processor; and
a memory configured to store instructions executable by the processor;
wherein the processor is configured to, when the executable instructions are run, implement the information processing method of any embodiment of the present disclosure.

According to a sixth aspect of the present disclosure, there is provided a computer storage medium. The computer storage medium stores a computer executable program, and when the executable program is executed by a processor, the information processing method of any embodiment of the present disclosure is implemented.

The technical solutions provided by the embodiments of the present disclosure may have the following beneficial effects:

In the embodiments of the present disclosure, configuration information may be sent through a base station. The configuration information includes RB indication information indicating the number of RBs with the same precoding for a UE. The number of RBs is used for the UE to determine an AI model for performing channel estimation, so that after the introduction of a PRB bundling configuration, the UE can use a suitable AI model to perform channel estimation for the number of RBs with the same precoding. In this way, the technical solution can adapt to change(s) in channel estimation of DMRSs of different numbers of RBs after the PRB bundling configuration, thereby improving the scalability of the AI method in the field of channel estimation. Moreover, since the DMRSs of the number of RBs with the same precoding can be input into the AI model as joint input data, the working efficiency and performance of the AI method in the field of channel estimation can also be improved.

It should be understood that the foregoing general description and the following detailed description are exemplary and explanatory only and are not restrictive of the embodiments of the present disclosure.

### BRIEF DESCRIPTION OF THE DRAWINGS

FIG. 1 is a schematic diagram of a structure of a wireless communication system according to an example embodiment of the present disclosure.

FIG. 2 is a flowchart showing an information processing method according to an example embodiment of the present disclosure.

FIG. 3 is a flowchart showing an information processing method according to an example embodiment of the present disclosure.

FIG. 4 is a flowchart showing an information processing method according to an example embodiment of the present disclosure.

FIG. 5 is a flowchart showing an information processing method according to an example embodiment of the present disclosure.

FIG. 6 is a flowchart showing an information processing method according to an example embodiment of the present disclosure.

FIG. 7 is a flowchart showing an information processing method according to an example embodiment of the present disclosure.

FIG. 8 is a flowchart showing an information processing method according to an example embodiment of the present disclosure.

FIG. 9 is a block diagram showing an information processing apparatus according to an example embodiment of the present disclosure.

FIG. 10 is a block diagram showing an information processing apparatus according to an example embodiment of the present disclosure.

FIG. 11 is a block diagram of a UE according to an example embodiment.

FIG. 12 is a block diagram of a base station according to an example embodiment.

### DETAILED DESCRIPTION

Reference will now be made in detail to exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of the present disclosure. Rather, they are merely examples of apparatuses and methods consistent with aspects of the disclosed embodiments as recited in the appended claims.

Terms used in the embodiments of the present disclosure are for the purpose of describing specific embodiments only, and are not intended to limit the embodiments of the present disclosure. As used in the examples of the present disclosure and the appended claims, singular forms “a/an” and “the” are also intended to include a plural form unless the context clearly indicates otherwise. It should also be understood that the term “and/or” as used herein refers to and includes any or all possible combinations of one or more of associated listed items.

It should be understood that although the terms first, second, third, etc. may be used to describe various information in the embodiments of the present disclosure, the information should not be limited by these terms. These terms are only used to distinguish information of the same type from each other. For example, without departing from the scope of the embodiments of the present disclosure, first information may also be called second information, and similarly second information may also be called first information. Depending on the context, the word “if” as used herein may be interpreted as “when” or “upon . . . ” or “in response to determining . . . ”.

FIG. 1 shows a schematic diagram showing the structure of a wireless communication system provided by an embodiment of the present disclosure. As shown in FIG. 1, the wireless communication system is a communication system based on a cellular mobile communication technology, and the wireless communication system may include: several user equipments 110 and several base stations 120.

A user equipment 110 may be a device that provides voice and/or data connectivity to a user. The user equipment 110 may communicate with one or more core networks via a Radio Access Network (RAN). The user equipment 110 may be an Internet of Things user equipment, such as a sensor device, a mobile phone (or referred to as a “cellular” phone), and a computer with an Internet of Things user equipment, for example, it may be a fixed, portable, pocket-sized, handheld, computer-built-in or vehicle-mounted device, for example, Station (STA), subscriber unit, subscriber station, mobile station, mobile, remote station, access point, remote user equipment (remote terminal), access user equipment (access terminal), user device (user terminal), user agent, user device, or user equipment. Alternatively, the user equipment 110 may be equipment of an unmanned aerial vehicle. Alternatively, the user equipment 110 may be a vehicle-mounted device, for example, a trip computer with a wireless communication function, or a wireless user device connected externally to a trip computer. Alternatively, the user equipment 110 may be a roadside device, for example, it may be a streetlight, a signal light or other roadside device with a wireless communication function.

A base station 120 may be a network side device in a wireless communication system. The wireless communication system may be a 4th generation mobile communication (4G) system, also known as a Long Term Evolution (LTE) system; or, the wireless communication system may be a 5G system, also called new radio system or 5G NR system. Alternatively, the wireless communication system may be a next-generation system of the 5G system. An access network in the 5G system may be called New Generation-Radio Access Network (NG-RAN).

The base station 120 may be an evolved base station (eNB) adopted in a 4G system. Alternatively, the base station 120 may be a base station (gNB) adopting a centralized and distributed architecture in the 5G system. When the base station 120 adopts a centralized and distributed architecture, it generally includes a central unit (CU) and at least two distributed units (DUs). The central unit is provided with a protocol stack of a Packet Data Convergence Protocol (PDCP) layer, a Radio Link Control (RLC) layer, and Medium Access Control (MAC) layer protocol stack; the distributed unit is provided a physical (PHY) layer protocol stack; embodiments of the present disclosure do not limit the specific implementation of the base station 120.

A wireless connection may be established between the base station 120 and the user equipment 110 through a wireless air interface. In different implementations, the wireless air interface is a wireless air interface based on the fourth-generation mobile communication network technology (4G) standard; or, the wireless air interface is a wireless air interface based on the fifth-generation mobile communication network technology (5G) standard, such as the wireless air interface is a new air interface; alternatively, the wireless air interface may also be a wireless air interface based on a technical standard of a next-generation mobile communication network based on 5G.

In some embodiments, an End to End (E2E) connection may be established between user equipments 110. For example, Vehicle to Vehicle (V2V) communication, Vehicle to Infrastructure (V2I) communication and Vehicle to Pedestrian (V2P) communication in Vehicle to everything (V2X) communication and so on.

Here, the above user equipment may be regarded as the terminal device in the following embodiments.

In some embodiments, the foregoing wireless communication system may further include a network management device 130.

Several base stations 120 are connected to the network management device 130 respectively. The network management device 130 may be a core network device in the wireless communication system. For example, the network management device 130 may be a Mobility Management Entity (MME) in an Evolved Packet Core (EPC). Alternatively, the network management device may be other core network device, such as a Serving GateWay (SGW), a Public Data Network Gate Way (PGW), a Policy and Charging Rules Function (PCRF) or Home Subscriber Server (HSS), etc. The implementation form of the network management device 130 is not limited in the embodiments of the present disclosure.

In order to facilitate the understanding of those skilled in the art, the embodiments of the present disclosure list a plurality of implementations to clearly illustrate the technical solutions of the embodiments of the present disclosure. Of course, those skilled in the art can understand that the plurality of implementations provided by the embodiments of the present disclosure may be performed independently, or combined with methods of other embodiments among embodiments of the present disclosure, or an implementation performed independently or implementations performed with other embodiments may be performed in combination with some methods in other related technologies; the embodiments of the present disclosure do not limit this.

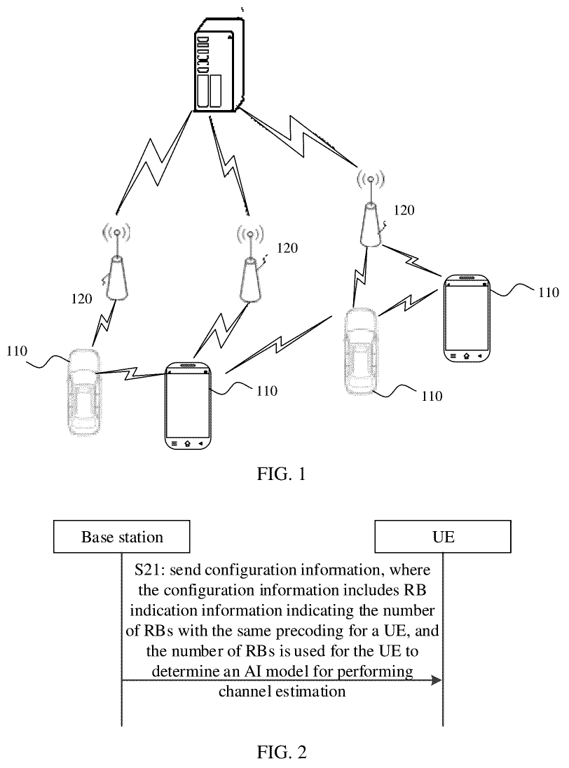

As shown in FIG. 2, an embodiment of the present disclosure provides an information processing method, which is performed by a base station and includes:

In step S21, configuration information is sent. The configuration information includes RB indication information indicating the number of RBs with the same precoding for a UE. The number of RBs is used for the UE to determine an AI model for performing channel estimation.

In one embodiment, the base station may be of various types. For example, the base station may be a 2G base station, a 3G base station, a 4G base station, a 5G base station or other evolved base station.

In one embodiment, the UE may be of terminal(s) of various types. For example, the UE may be, but not limited to, a mobile phone, a computer, a server, a wearable device, a game control platform, or a multimedia device, or the like.

Step S21 may be that the base station sends configuration information to the UE.

In one embodiment, the number of RBs with the same precoding includes: the number of consecutive RBs with the same precoding. For example, the RB indication information indicates the number of consecutive RBs with the same precoding for the UE.

In one embodiment, DMRS(s) of the number of consecutive RBs is (are) input as an input parameter to the AI model. For example, the DMRSs of the number of consecutive RBs are input as joint data to the AI model for channel estimation. Here, the channel estimation may be joint channel estimation.

In one embodiment, the number of RBs includes the number of PRBs. For example, the RB indication information indicates the number of consecutive PRBs with the same precoding for the UE.

In one embodiment, the configuration information includes PRB bundling configuration information. The PRB bundling configuration information includes the RB indication information.

In other embodiments, the PRB bundling configuration information may also include, but is not limited to, at least one of the following: type information indicating the type of the PRB bundling configuration, and value information indicating the value of the number of RBs in the PRB bundling configuration. The value information may include: first value information indicating that the number of RBs is a first type of value, or second value information indicating that the number of RBs is a second type of value.

In some embodiments, the configuration information includes model indication information, where the model indication information indicates an AI model adopted by the UE.

In one embodiment, the RB indication information may be RB_indicator; and the model indication information may be: Model_indicator.

In some embodiments, the configuration information may be used for the UE to determine the AI model for performing channel estimation. For example, the number of RBs with the same precoding indicated by the RB indication information in the configuration information is used for the UE to determine the AI model to perform channel estimation. For another example, the number of RBs with the same precoding indicated by the RB indication information in the configuration information is used to determine corresponding model indication information; the model indication information is used for the UE to determine the AI model to perform channel estimation. For another example, the model indication information in the configuration information is used for the UE to determine the AI model to perform channel estimation.

In some embodiments, the number of RBs is used by the UE to determine the AI model for channel estimation when PRB bundling is configured.

Here, the PRB bundling configuration includes but is not limited to at least one of the following: a semi-static PRB bundling configuration; or a dynamic PRB bundling configuration.

Here, the semi-static PRB bundling configuration may be a configuration based on Radio Resource Control (RRC) signaling. For example, the base station sends the configuration information to the UE through the RRC signaling.

Here, the dynamic PRB bundling configuration may be a configuration based on a Physical Downlink Control Channel (PDCCH). For example, the base station sends the configuration information to the UE through the PDCCH.

In one embodiment, a usage time corresponding to the semi-static PRB bundling configuration is greater than a usage time corresponding to the dynamic PRB bundling configuration. For example, one semi-static PRB bundling configuration is performed for a UE, and the usage time corresponding to the semi-static PRB bundling configuration may be a first time. One dynamic PRB bundling configuration is performed for the UE, and the usage time corresponding to the dynamic PRB bundling configuration may be a second time. The first time is greater than the second time.

In the embodiments of the present disclosure, the configuration information may be sent through a base station, and the configuration information includes the RB indication information indicating the number of RBs with the same precoding for the UE. The number of RBs is used for the UE to determine the AI model for performing channel estimation, so that after the introduction of the PRB bundling configuration, the UE can use a suitable AI model to perform channel estimation for the number of RBs with the same precoding. In this way, the technical solution can adapt to the change(s) in channel estimation for DMRSs of different numbers of RBs after the PRB bundling configuration, thereby improving the scalability of the AI method in the field of channel estimation. Moreover, since the DMRSs of the number of RBs with the same precoding can be input into the AI model as joint input data, the working efficiency and performance of the AI method in the field of channel estimation can also be improved.

Step 21 includes:
in response to the PRB bundling configuration of the UE being a semi-static PRB bundling configuration, sending Radio Resource Control (RRC) signaling carrying the configuration information; or
in response to the PRB bundling configuration of the UE being a dynamic PRB bundling configuration, sending the configuration information through a Physical Downlink Control Channel (PDCCH).

An embodiment of the present disclosure provides an information processing method, which is performed by a base station and may include: in response to the PRB bundling configuration of the UE being a semi-static PRB bundling configuration, sending RRC signaling carrying the configuration information; or, in response to the PRB bundling configuration of the UE being a dynamic PRB bundling configuration, sending the configuration information through a PDCCH. Here, sending the configuration information through the PDCCH includes: sending the configuration information on the PDCCH.

Thus, in the embodiments of the present disclosure, in one implementation, in response to a semi-static PRB bundling configuration for a UE, the configuration information may be sent through RRC signaling. In another implementation, in response to a dynamic PRB bundling configuration for a UE, the configuration information may be sent through the PDCCH. Thus, on the one hand, different PRB bundling configurations may be sent through different signaling or channels; on the other hand, by sending the configuration information through the RRC signaling or based on the PDCCH, the utilization rate of the RRC signaling or the PDCCH may be improved.

It should be noted that those skilled in the art can understand that the methods provided in the embodiments of the present disclosure may be performed independently, or may be performed in combination with some methods in the embodiments of the present disclosure or some methods in related technologies.

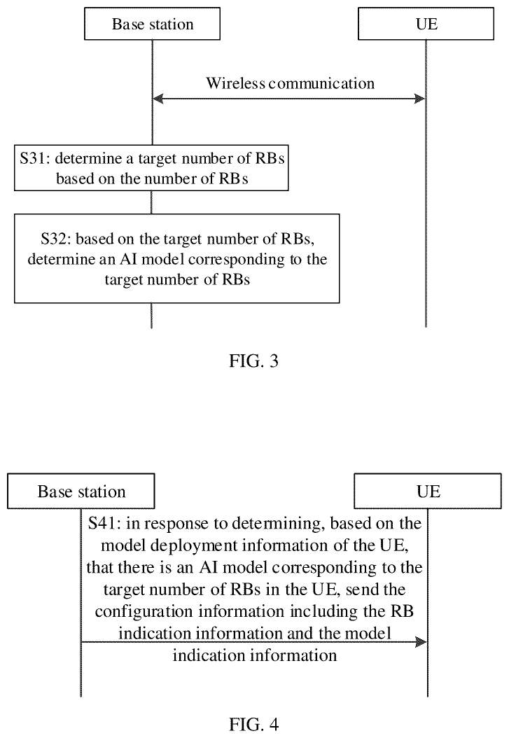

As shown in FIG. 3, an embodiment of the present disclosure provides an information processing method, which is performed by a base station and includes:

In step S31, a target number of RBs is determined based on the number of RBs.

In step S32, based on the target number of RBs, an AI model corresponding to the target number of RBs is determined.

Step S31 includes: determining the target number of RBs based on the number of RBs in a PRB bundling configuration.

An embodiment of the present disclosure provides an information processing method, which is performed by a base station and may include: determining a target number of RBs based on the number of RBs in the PRB bundling configuration; and based on the target number of RBs, determining an AI model corresponding to the target number of RBs.

Step S31 includes at least one of the following steps:
in response to the number of RBs being a first type of value, determining that the target number of RBs is equal to the number of RBs; or
in response to the number of RBs being a second type of value, determining the target number of RBs based on at least one of: computing capability information of the UE, storage capability information of the UE, channel quality information, or model deployment information of the UE.

In embodiments of the present disclosure, the model deployment information is used to indicate an AI model that the UE can use. The model deployment information may be an AI model that has been deployed in the UE, or an AI model that the UE can use according to a communication protocol or other configuration information.

In some embodiments, the model deployment information may include: the number of RBs and/or the AI model corresponding to the number of RBs.

In an embodiment of the present disclosure, the target number of RBs is the number of RBs corresponding to channel estimation performed by the UE. The AI model for channel estimation determined by the base station is the AI model corresponding to the target number of RBs.

Here, the second type of value is greater than the first type of value. For example, the first type of value is {2, 4}; the second type of value is a value of {wideband} greater than a predetermined value. For example, the second type of value is 10 or the total number of RBs in a certain frequency domain.

Here, the first type of value may be a fixed value. For example, the first type of value may be {2, 4. 6, 8}. The second type of value is a non-fixed value. For example, the second type of value may be {wideband} or at least part of the number of RBs in the total number of RBs in the frequency domain.

An embodiment of the present disclosure provides an information processing method, which is performed by a base station and includes: based on the number of RBs in the PRB bundling configuration being a first type of value, determining that the target number of RBs is equal to the number of RBs.

An embodiment of the present disclosure also provides an information processing method, which is performed by a base station and includes: based on the number of RBs in the PRB bundling configuration being a second type of value, determining the target number of RBs, based on at least one of: computing capability information of the UE, storage capability information of the UE, channel quality information, and model deployment information of the UE.

In some embodiments of the present disclosure, the PRB bundling configuration is the PRB bundling configuration in the above embodiments. For example, the PRB bundling configuration includes: a semi-static PRB bundling configuration or a dynamic PRB bundling configuration.

Here, the number of RBs in the PRB bundling configuration being a first type of value includes: the number of RBs in the semi-static PRB bundling configuration is the first type of value, or the number of RBs in the dynamic PRB bundling configuration is the first type of value. For example, the number of RBs in the semi-static PRB bundling configuration is “2” or “4”; or, the number of RBs in the dynamic PRB bundling configuration is “2” or “4”.

Here, the number of RBs in the PRB bundling configuration being a second type of value includes: the number of RBs in the semi-static PRB bundling configuration is the second type of value, or the number of RBs in the dynamic PRB bundling configuration is the second type of value. For example, the number of RBs in the dynamic PRB bundling configuration is “wideband”, or the number of RBs in the dynamic PRB bundling configuration is “wideband”.

For example, a network device performs a PRB bundling configuration for the UE. If the number of RBs in the PRB bundling configuration is 2, the target number of RBs is 2, and the base station indicates that the number of RBs is 2 through RB indication information, and determines an AI model corresponding to the number of RBs of 2 for the UE. Here, if the UE receives the RB indication information and determines that the number of RBs is 2 based on the RB indication information, the UE determines that the target number of RBs is 2, and the UE determines to use the AI model corresponding to the number of RBs of 2 to perform channel estimation. Here, the PRB bundling configuration is a semi-static PRB bundling configuration or a dynamic PRB bundling configuration.

For example, the network device performs a PRB bundling configuration for the UE. If the number of RBs in the PRB bundling configuration is “wideband”, the base station may determine the target number of RBs based on at least one of: computing capability information of the UE, storage capability information of the UE, channel quality information, and model deployment information of the UE. Here, if the UE receives the RB indication information and determines that the number of RBs is “wideband” based on the RB indication information, the UE may determine the AI model for performing channel estimation based on at least one of: the computing capability information of the UE, the storage capability information of the UE, the channel quality information, and the model deployment information of the UE.

Here, the strength of a computing capability indicated by the computing capability information of the UE is positively correlated with the magnitude of the number of RBs. That is, if the computing capability of the UE is stronger, the determined number of RBs is larger; if the computing capability of the UE is weaker, the determined number of RBs is smaller.

Here, the magnitude of a storage capability indicated by the storage capability information of the UE is positively correlated with the magnitude of the number of RBs. That is, if the storage capability of the UE is larger, the determined number of RBs is larger; if the storage capability of the UE is smaller, the determined number of RBs is smaller.

Here, the channel quality information indicates the quality of the channel environment and is positively correlated with the magnitude of the number of RBs. That is, the better the UE's channel environment, the larger the number of RBs determined; the worse the UE's channel environment, the smaller the number of RBs determined.

Here, determining the target number of RBs according to the model deployment information of the UE may be: determining the target number of RBs based on an AI model in the model deployment information of the UE. For example, the model deployment information includes: an AI model; the base station may determine the target number of RBs according to the performance of the AI model, such as the dimension of the input data of the AI model, etc.

Thus, in an embodiment of the present disclosure, if the PRB bundling configuration which is a semi-static PRB bundling configuration or a dynamic PRB bundling configuration is a first type of value, the target number of RBs required for channel estimation may be directly determined as the number of RBs which is the first type of value. Thus, the appropriate number of RBs for joint channel estimation can be conveniently determined.

Alternatively, if the PRB bundling configuration which is the semi-static PRB bundling configuration or the dynamic PRB bundling configuration is the second type of value, the base station may determine the target number of RBs required for channel estimation based on at least one of: the computing capability information of the UE, the storage capability information of the UE, the channel quality information, and the model deployment information of the UE. In this way, the base station can freely select the number of RBs for joint channel estimation based on the computing capability of the UE, the storage capability of the UE, the channel environment, and the AI model in the UE and so on, thereby maximizing resource utilization.

An embodiment of the present disclosure provides an information processing method, which is performed by a base station, and includes: determining model deployment information of the UE; and storing identity information of the UE and corresponding model deployment information.

In one embodiment, the model deployment information is used to indicate a corresponding relationship between the number(s) of RBs and AI model(s). For example, the model deployment information may be: when the number of RBs is determined to be 2, the corresponding AI model is a first AI model; when the number of RBs is determined to be 4, the corresponding AI model is a second AI model; and when the number of RBs is determined to be 6, the corresponding AI model is a third AI model.

In another embodiment, the model deployment information includes at least one of the following parameter(s): an AI model that the UE can use, the number of RBs, or an AI model corresponding to the number of RBs. For example, when the base station determines that the number of RBs is 2, the corresponding AI model is the first AI model; when the number of RBs is 4, the corresponding AI model is the second model. Determination is also made when the AI model of the UE is the third AI model and the fourth AI model, and there is a situation where the number of RBs is 6 in the PRB bundling configuration corresponding to the UE. The base station determining the model deployment information of the UE may include at least one of: the number of RBs being 2 and the corresponding first AI model, the number of RBs being 4 and the corresponding second AI model, and the third AI model and the fourth AI model and the number of RBs being 6. That is, the model deployment information may identify the AI models (the first AI model, the second AI model, the third AI model, the fourth AI model) that the UE can use; it may also identify the number of RBs corresponding to an AI model; it may also identify the number(s) of RBs corresponding to the UE. Of course, the above example includes three parameters at the same time, and those skilled in the art can understand that only one of the parameters can be included.

In some embodiments of the present disclosure, the number of RBs is the target number of RBs. For example, the model deployment information includes: at least one corresponding relationship between the target number of RBs and the AI model; or, the model deployment information includes: at least one target number of RBs and/or an AI model corresponding to the target number of RBs.

An embodiment of the present disclosure provides an information processing method, which is performed by a base station and includes: sending, to the UE, the model deployment information of the UE.

Thus, in the embodiments of the present disclosure, the model deployment information of the UE can be determined by the base station, so that it is convenient to subsequently query whether the UE has an AI model corresponding to the number of RBs (or the target number of RBs). And, the model deployment information of the UE can be sent to the UE by the base station, so that the UE can determine the AI model corresponding to the number of RBs (or the target number of RBs) for channel estimation based on the RB indication information in the received configuration information and/or AI model information.

Step S21 includes: in response to determining, based on the model deployment information, that there is an AI model corresponding to the number of RBs in the UE, sending the configuration information including the RB indication information and the model indication information.

Step S21 includes: in response to determining, based on the model deployment information, that there is no AI model corresponding to the number of RBs in the UE, sending the configuration information including at least the RB indication information.

In one embodiment, the number of RBs includes the target number of RBs. Here, the RB indication information indicates the target number of RBs with the same precoding. Here, the target number of RBs with the same precoding may be: the target number of consecutive RBs with the same precoding.

Step S21 includes: in response to determining, based on the model deployment information of the UE, that there is an AI model corresponding to the target number of RBs in the UE, sending the configuration information including the RB indication information and the model indication information.

Step S21 includes: in response to determining, based on the model deployment information of the UE, that there is no AI model corresponding to the target number of RBs in the UE, sending the configuration information including at least the RB indication information.

It can be understood that the above two steps may be performed separately or together; the embodiments of the present disclosure are not limited to this.

As shown in FIG. 4, an embodiment of the present disclosure provides an information processing method, which is performed by a base station and includes:

In step S41, in response to determining, based on the model deployment information of the UE, that there is an AI model corresponding to the target number of RBs in the UE, the configuration information including the RB indication information and the model indication information is sent.

For example, if the number of RBs configured by the network device for the PRB bundling configuration of the UE is the first type of value, the number of RBs is the target number of RBs. The base station queries the model deployment information of the UE. If there is an AI model corresponding to the number of RBs in the model deployment information, the base station sends the configuration information to the UE, and the configuration information includes: the RB indication information indicating the number of RBs with the same precoding, and the model indication information indicating the AI model. When the UE receives the configuration information, it can perform channel estimation directly based on the AI model indicated by the model indication information. Here, the PRB bundling configuration of the UE may be a semi-static PRB bundling configuration or a dynamic PRB bundling configuration.

For example, if the number of RBs configured by the network device for the PRB bundling configuration of the UE is the second type of value, the base station determines the target number of RBs based on at least one of: the computing capability information of the UE, the storage capability information of the UE, the channel quality information, or the model deployment information of the UE. The base station queries the model deployment information of the UE. If there is an AI model corresponding to the target number in the model deployment information, the base station sends the configuration information to the UE, and the configuration information includes: the RB indication information indicating the target number of RBs with the same precoding, and the model indication information indicating the AI model. When the UE receives the configuration information, it can directly perform channel estimation based on the AI model indicated by the model indication information. Here, the PRB bundling configuration of the UE may be a semi-static PRB bundling configuration or a dynamic PRB bundling configuration.

Thus, in the embodiments of the present disclosure, if there is an AI model corresponding to the number of RBs (or the target number of RBs) in the model deployment information of the UE, the configuration information including the RB indication information and the model indication information can be sent through the base station, so that the UE can directly perform channel estimation based on the RB indication information and the model indication information using the AI model corresponding to the number of RBs (or the target number of RBs).

In some embodiments of the present disclosure, if the base station determines that there is an AI model corresponding to the target number of RBs in the model deployment information of the UE, it may also only send the RB indication information, so that the UE determines the target number of RBs based on the RB indication information, and then determines the AI model corresponding to the target number of RBs based on the target number of RBs and the model deployment information of the UE. For example, an embodiment of the present disclosure provides an information method, which is performed by the base station and includes: determining, based on the model deployment information of the UE, that an AI model corresponding to the target number of RBs exists in the UE, and sending the configuration information including the RB indication information; where the RB indication information is used for the UE to determine the target number of RBs; the target number of RBs is used for the UE to determine the AI model for channel estimation.

Here, the target number of RBs is used for the UE to determine, based on the target number of RBs and the model deployment information, the AI model corresponding to the target number of RBs to perform channel estimation. Here, the model deployment information includes: a corresponding relationship between the number of RBs and the AI model.

For example, if the number of RBs configured by the network device for the PRB bundling configuration of the UE is the first type of value, the number of RBs is the target number of RBs. The base station queries the model deployment information of the UE. If there is an AI model corresponding to the number of RBs in the model deployment information, the base station sends the configuration information to the UE, and the configuration information includes: the RB indication information indicating the number of RBs with the same precoding. When the UE receives the configuration information, it can determine the number of RBs based on the RB indication information, and determine, based on the number of RBs and the model deployment information of the UE, the AI model corresponding to the number of RBs to perform channel estimation. Here, the model deployment information of the UE includes: a corresponding relationship between the number of RBs and the AI model. Here, the PRB bundling configuration of the UE may be a semi-static PRB bundling configuration or a dynamic PRB bundling configuration.

For example, if the number of RBs configured by the network device for the PRB bundling configuration of the UE is the second type of value, the base station determines the target number of RBs based on at least one one of: the computing capability information of the UE, the storage capability information of the UE, the channel quality information, or the model deployment information of the UE. The base station queries the model deployment information of the UE. If there is an AI model corresponding to the target number in the model deployment information, the base station sends the configuration information to the UE, and the configuration information includes: the RB indication information indicating the target number of RBs with the same precoding. When the UE receives the configuration information, it may determine the target number of RBs based on the RB indication information, and determine, based on the target number of RBs and the model deployment information of the UE, the AI model corresponding to the target number of RBs to perform channel estimation. Here, the model deployment information of the UE includes: a corresponding relationship between the target number of RBs and the AI model. Here, the PRB bundling configuration of the UE may be a semi-static PRB bundling configuration or a dynamic PRB bundling configuration.

As such, in the embodiments of the present disclosure, the configuration information including only the RB indication information may be sent to the UE by the base station, thereby reducing the number of bits in the configuration information and saving transmission resource(s).

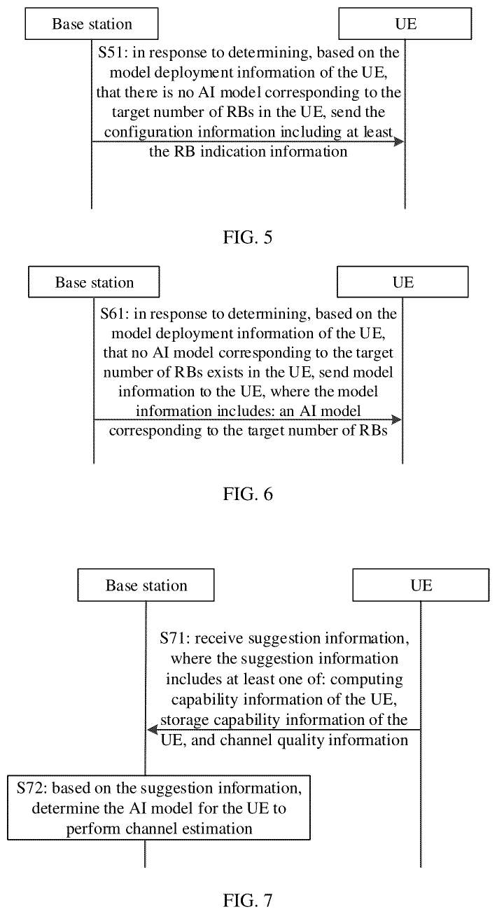

As shown in FIG. 5, an embodiment of the present disclosure provides an information processing method, which is performed by a base station and includes:

In step S51, in response to determining, based on the model deployment information of the UE, that there is no AI model corresponding to the target number of RBs in the UE, the configuration information including at least the RB indication information is sent.

Here, the RB indication information is used for the UE to determine the target number of RBs; the target number of RBs is used for the UE to determine the AI model for performing channel estimation.

Here, the target number of RBs is used for the UE to determine the AI model for performing channel estimation based on the computing capability information of the UE, the storage capability information of the UE, the channel quality information, and the model deployment information of the UE.

Here, the strength of the computing capability indicated by the computing capability information of the UE, the magnitude of the storage capability indicated by the storage capability of the UE, and the quality of the channel environment indicated by the channel quality may all be positively correlated with the working performance of the AI model, for example, positively correlated with the size of the dimension of the input data of the AI model or positively correlated with the size of the data amount processed by the AI model. For example, the stronger the computing capability of the UE, the greater the storage capability of the UE, and/or the better the channel quality of the UE, the larger the dimension of the input data of the AI model; the weaker the computing capability of the UE, the smaller the storage capability of the UE, and/or the worse the channel quality of the UE, the smaller the dimension of the input data of the AI model.

Here, determining the AI model according to the model deployment information of the UE may be that: the determined AI model belongs to AI model(s) included in the model deployment information.

Here, sending the configuration information including at least the RB indication information may be: sending the configuration information including the RB indication information.

For example, if the number of RBs configured by the network device for the PRB bundling configuration of the UE is the first type of value, the number of RBs is the target number of RBs. The base station queries the model deployment information of the UE. If an AI model corresponding to the number of RBs does not exist in the model deployment information, the base station sends the configuration information to the UE, and the configuration information includes: the RB indication information indicating the number of RBs with the same precoding. When the UE receives the RB indication information, it may determine the number of RBs based on the RB indication information, and determine, based on the computing capability information of the UE, the storage capability information of the UE, the channel quality information and the model deployment information of the UE, the AI model to perform channel estimation. Here, the PRB bundling configuration of the UE may be a semi-static PRB bundling configuration or a dynamic PRB bundling configuration.

For example, if the number of RBs configured by the network device for the PRB bundling configuration of the UE is the second type of value, the base station determines the target number of RBs based on one of: the computing capability information of the UE, the storage capability information of the UE, the channel quality information, and the model deployment information of the UE. The base station queries the model deployment information of the UE. If there is no AI model corresponding to the target number in the model deployment information, the base station sends the configuration information to the UE, and the configuration information includes: the RB indication information indicating the target number of RBs with the same precoding. When the UE receives the RB indication information, it may determine the target number of RBs based on the RB indication information; and determine, based on the computing capability information of the UE, the storage capability information of the UE, the channel quality information and the model deployment information of the UE, the AI model to perform channel estimation. Here, the PRB bundling configuration of the UE may be a semi-static PRB bundling configuration or a dynamic PRB bundling configuration.

Here, sending the configuration information including at least the RB indication information may include: sending the model indication information indicating an AI model and the configuration information including the RB indication information. In this way, an AI model that needs to be used for channel estimation may be indicated to the UE by sending the model indication information.

Thus, in the embodiments of the present disclosure, if the base station determines that there is no AI model corresponding to the number of RBs (or the target number of RBs) in the model deployment information of the UE, the base station sends the configuration information including at least the RB indication information to the UE, so that the UE can determine the number of RBs (or the target number of RBs) based on the RB indication information, and then determine the AI model for channel estimation based on the model deployment information of the UE, the computing capability information, the storage capability information and the channel quality information, and so on. In this way, the UE can freely select a suitable AI model for performing channel estimation, and the resource utilization can be maximized. Moreover, by sending the configuration information including only the RB indication information to the UE by the base station, the number of bits in the configuration information can be reduced, thereby saving transmission resource(s).

Step 21 includes: in response to determining, based on the model deployment information of the UE, that no AI model corresponding to the target number of RBs exists in the UE, sending the configuration information including RB indication information;

The following is also included: sending model information to the UE, where the model information includes an AI model corresponding to the target number.

Here, sending the configuration information including the RB indication information may also mean sending the configuration information including the RB indication information and the model indication information.

As shown in FIG. 6, an embodiment of the present disclosure provides an information processing method, which is performed by a base station and includes:

In step S61, in response to determining, based on the model deployment information of the UE, that no AI model corresponding to the target number of RBs exists in the UE, model information is sent to the UE. The model information includes: an AI model corresponding to the target number of RBs.

In one embodiment, the model deployment information includes: model information.

Sending the model information to the UE in Step S61 of includes:
based on the PRB bundling configuration of the UE being a semi-static PRB bundling configuration, sending RRC signaling carrying the model information; or
based on the PRB bundling configuration of the UE being a dynamic PRB bundling configuration, sending the model information through the PDCCH.

An embodiment of the present disclosure provides an information processing method, which is performed by a base station and includes: based on the PRB bundling configuration of the UE being a semi-static PRB bundling configuration, sending RRC signaling carrying the model information; or, based on the PRB bundling configuration of the UE being a dynamic PRB bundling configuration, sending the model information through the PDCCH.

Here, the AI model included in the model information is the AI model indicated by the model indication information.

For example, if the number of RBs configured by the network device for the PRB bundling configuration of the UE is the first type of value, the number of RBs is the target number of RBs. The base station queries the model deployment information of the UE. If an AI model corresponding to the number of RBs does not exist in the model deployment information, the base station sends the configuration information to the UE through RRC signaling, and the configuration information includes: the RB indication information indicating the number of RBs with the same precoding and indication information indicating an AI model. And, the base station sends model information to the UE through the RRC signaling, and the model information includes the AI model indicated by the model indication information. When the UE receives the RB indication information, the model indication information and the AI model, it may determine the AI model used by the UE for channel estimation. Here, the PRB bundling configuration of the UE may be a semi-static PRB bundling configuration or a dynamic PRB bundling configuration.

For example, if the number of RBs configured by the network device for the PRB bundling configuration of the UE is the second type of value, the base station determines the target number of RBs based on at least one of: the computing capability information of the UE, the storage capability information of the UE, the channel quality information, or the model deployment information of the UE. The base station queries the model deployment information of the UE. If there is no AI model corresponding to the target number in the model deployment information, the base station sends the configuration information to the UE through the PDCCH, and the configuration information includes: the RB indication information indicating the number of target RBs with the same precoding and indication information indicating the AI model. And, the base station sends model information to the UE through the PDCCH, and the model information includes the AI model indicated by the model indication information. When the UE receives the model indication information and the AI model, it may determine the AI model used by the UE for channel estimation. Here, the PRB bundling configuration of the UE may be a semi-static PRB bundling configuration or a dynamic PRB bundling configuration.

Thus, in an embodiment of the present disclosure, if the base station determines that there is no AI model corresponding to the number of RBs (target number of RBs) in the model deployment information of the UE, the AI model can be sent directly to the UE. Thus, the UE can subsequently perform channel estimation based on the AI model.

Moreover, for AI models for different PRB bundling configuration types, the AI models may be sent through different signaling or channels. For example, for a UE with a semi-static PRB bundling configuration, the AI model may be sent to the UE through the RRC signaling, or for a UE with a dynamic PRB bundling configuration, the AI model may be sent to the UE through the PDCCH. In this way, appropriate signaling or channels can be used for UEs with different PRB bundling configurations, which can improve the success rate for UEs to receive AI models.

An embodiment of the present disclosure provides an information processing method, which is performed by a base station and may include:
in response to the PRB bundling configuration of the UE being a dynamic PRB bundling configuration, obtaining a transmission time for transmitting the AI model;
adjusting a slot offset between the PDCCH and a corresponding Physical Downlink Shared Channel (PDSCH) and sending the slot offset to the UE, where the time indicated by the slot offset is greater than the transmission time.

Here, the slot offset may be used by the UE to determine whether the AI model can be used for channel estimation. For example, if the slot offset is greater than or equal to the transmission time, it is determined that the AI model can be used for channel estimation; or, if the slot offset is less than the transmission time, it is determined that the AI model cannot be used for channel estimation.

Here, if the time indicated by the slot offset is greater than the transmission slot, it can be ensured that the UE has completed receiving of the AI model when the PDSCH reaches the UE, and accordingly the UE can perform channel estimation based on the AI model.

In some embodiments, obtaining the transmission time for transmitting the AI model may include: obtaining the transmission time for transmitting the AI model based on at least one of: data processing amount of the AI model, a transmission time based on historical transmission of the AI model, the number of RBs corresponding to the AI model, and the number of bits occupied by the AI model. Of course, obtaining the transmission time for transmitting the AI model may also be determined in any implementable manner, which is not limited here.

For example, the network device configures the PRB bundling configuration of the UE as a dynamic PRB bundling configuration. If the number of RBs in the dynamic PRB bundling configuration is the first type of value, the number of RBs is the target number of RBs; if the number of RBs in the dynamic PRB bundling configuration is the second type of value, the base station determines the target number of RBs based on one of: the computing capability information of the UE, the storage capability information of the UE, the channel quality information, and the model deployment information of the UE. The base station queries the model deployment information of the UE. If there is no AI model corresponding to the target number in the model deployment information, the base station determines the AI model corresponding to the target number of RBs and determines the transmission time for transmitting the AI model. The base station sends, through the PDCCH, the configuration information, the slot offset and the model information to the UE. The configuration information includes: the RB indication information indicating the target number of RBs with the same precoding and indication information indicating the AI model. The model information includes the AI model corresponding to the target number of RBs. The time indicated by the slot offset is greater than the transmission time. When the UE receives the configuration information and the AI model, it may determine the AI model and determine whether the AI model can be used for channel estimation according to the slot offset.

Thus, in the embodiments of the present disclosure, if the PRB bundling configuration of the UE is the dynamic PRB bundling configuration, the base station also obtains the transmission time for transmitting the AI model and sends the slot offset to the UE, and the time indicated by the slot offset is greater than the transmission time. In this way, it can be ensured as much as possible that the UE has completed receiving of the AI model when the PDSCH reaches the UE, thereby improving the availability for the AI model to be used for channel estimation and improving the UE's ability to perform channel estimation based on the AI model.

It should be noted that those skilled in the art can understand that the methods provided in the embodiments of the present disclosure may be performed independently, or combined with methods of other embodiments of the present disclosure or some methods in relate technologies.

As shown in FIG. 7, an embodiment of the present disclosure provides an information processing method, which is performed by a base station and includes:

In step S71, suggestion information is received. The suggestion information includes at least one of: computing capability information of the UE, storage capability information of the UE, and channel quality information.

In step S72, based on the suggestion information, the AI model for the UE to perform channel estimation is determined.

Step S71 may be: receiving suggestion information sent by the UE.

Here, the strength of the computing capability indicated by the computing capability information of the UE, the magnitude of the storage capability indicated by the storage capability of the UE, and the quality of the channel environment indicated by the channel quality information may all be positively correlated with the working performance of the AI model, for example, positively correlated with the size of the dimension of the input data of the AI model or positively correlated with the size of the data amount processed by the AI model. For example, the stronger the computing capability of the UE, the greater the storage capability of the UE, and/or the better the channel quality of the UE, the larger the dimension of the input data of the AI model; the weaker the computing capability of the UE, the smaller the storage capability of the UE, and/or the worse the channel quality of the UE, the smaller the dimension of the input data of the AI model.

Here, the base station can determine the AI model for the UE in advance based on the suggestion information, or when it is queried that there is no AI model corresponding to the target number of RBs in the model deployment information of the UE, the base station can determine the AI model of the UE based on the suggestion information.

In this way, the embodiment of the present disclosure can determine a suitable AI model for the UE based on the suggestion information reported by the UE.

Here, step S71 may include: receiving suggestion information sent by a UE with a semi-static PRB bundling configuration or receiving suggestion information sent by a UE with a dynamic PRB bundling configuration.

In one embodiment, before step S71, the method includes: the base station sends request information to the UE, where the request information is used to indicate the UE to send the suggestion information.

Thus, in the embodiment of the present disclosure, the base station can receive the suggestion information reported by the UE only when it needs to request the UE to report the suggestion information. Thus, the base station does not need to receive the suggestion information in real time to determine the AI model for the UE to perform channel estimation, thereby saving transmission resource(s) and processing resource(s).

It should be noted that those skilled in the art can understand that the methods provided in the embodiments of the present disclosure may be performed independently, or combined with methods of other embodiments of the present disclosure or some methods in relate technologies.

The following describes an information processing method performed by the UE, which is similar to the description of the information processing method performed by the base station mentioned above. For technical details not disclosed in the embodiments of the information processing method performed by the UE, reference may be made to the description of the examples of the information processing method performed by the base station, and repeated description is omitted here.

An embodiment of the present disclosure provides an information processing method, which is performed by a UE, and includes: based on the number of RBs with the same precoding, determining an AI model to perform channel estimation.

An embodiment of the present disclosure provides an information processing method, which is performed by a UE and may include: when PRB bundling configuration is performed, based on the number of RBs with the same precoding, determining an AI model to perform channel estimation.

As shown in FIG. 8, an embodiment of the present disclosure provides an information processing method, which is performed by a UE and includes:

In step S81, configuration information is received. The configuration information includes RB indication information indicating the number of RBs with the same precoding for the UE.

In step S82, based on the number of RBs, an AI model is determined to perform channel estimation.

The configuration information includes: model indication information.

An embodiment of the present disclosure provides an information processing method, which is performed by a UE and includes: receiving the configuration information, where the configuration information includes: the RB indication information and the model indication information.

In some embodiments of the present disclosure, the configuration information is the configuration information in step S21; the RB indication information is the RB indication information in step S21; the number of RBs is the number of RBs in step S21; the model indication information is the model indication information in the above embodiments, and the AI model is the AI model in the above embodiments.

Step S82 may include: based on the number of RBs in the PRB bundling configuration, determining the AI model to perform channel estimation. Here, the PRB bundling configuration is the PRB bundling configuration in the above embodiments. For example, the PRB bundling configuration may be a semi-static PRB bundling configuration or a dynamic PRB bundling configuration.

The configuration information includes: model indication information indicating the AI model adopted by the UE.

Step S82 may include: determining to perform channel estimation based on an AI model indicated by the model indication information corresponding to the number of RBs.

An embodiment of the present disclosure provides an information processing method, which is performed by a UE and includes: receiving configuration information, where the configuration information includes: RB indication information indicating the number of RBs with the same precoding for the UE; and the model indication information indicating the AI model adopted by the UE; and performing channel estimation based on the AI model indicated by the model indication information corresponding to the number of RBs.

The number of RBs includes: the target number of RBs.

An embodiment of the present disclosure provides an information processing method, which is performed by a UE and includes: receiving the configuration information, where the configuration information includes: the RB indication information indicating the target number of RBs with the same precoding for the UE; and the model indication information indicating the AI model adopted by the UE; and performing channel estimation based on the AI model indicated by the model indication information corresponding to the target number of RBs.

Step S82 may include: in response to the number of RBs being a first type of value, determining an AI model corresponding to the number of RBs to perform channel estimation. Here, based on the number of RBs may include: based on the number of RBs in the PRB bundling configuration.

An embodiment of the present disclosure provides an information processing method, which is performed by a UE and includes: receiving the configuration information, where the configuration information includes: the RB indication information indicating the number of RBs with the same precoding of the UE; and in response to the number of RBs being a first type of value, performing channel estimation based on an AI model corresponding to the number of RBs. Here, the UE performing channel estimation based on the AI model corresponding to the number of RBs may be: based on the number of RBs and the model deployment information of the UE, the UE determining the AI model corresponding to the number of RBs; and performing channel estimation based on the AI model.

Step S82 may include: in response to the number of RBs being the second type of value, determining the AI model to perform channel estimation based on at least one of: model deployment information of the UE, computing capability information of the UE, storage capability information of the UE, and channel quality information. Here, based on the number of RBs may include: based on the number of RBs in the PRB bundling configuration.

Here, the number of RBs includes: the target number of RBs.

An embodiment of the present disclosure provides a processing method, which is performed by a UE and includes: receiving the configuration information, where the configuration information includes: the RB indication information indicating the target number of RBs with the same precoding for the UE; and in response to the target number of RBs being a second type of value, determining an AI model to perform channel estimation based on at least one of: the model deployment information of the UE, the computing capability information of the UE, the storage capability information of the UE, and the channel quality information.

The number of RBs may include: the target number of RBs.

The method may include: receiving model information, where the model information includes an AI model corresponding to the target number of RBs.

Step S82 may include: determining an AI model corresponding to the target number of RBs to perform channel estimation.

An embodiment of the present disclosure provides a processing method, which is performed by a UE and includes: receiving the configuration information, where the configuration information includes: the RB indication information indicating the target number of RBs with the same precoding for the UE; receiving the model information, where the model information includes an AI model corresponding to the target number of RBs; and determining the AI model corresponding to the target number of RBs to perform channel estimation.

Step S81 may include:
receiving RRC signaling carrying the configuration information; where the RRC signaling is sent when the base station determines that the PRB bundling configuration for the UE is a semi-static PRB bundling configuration, or
receiving the configuration information sent through a PDCCH, where the configuration information is sent when the base station determines that the PRB bundling configuration for the UE is a dynamic PRB bundling configuration.

An embodiment of the present disclosure provides an information processing method, which is performed by a UE and may include: receiving RRC signaling carrying the configuration information; where the RRC signaling is sent when the base station determines that the PRB bundling configuration for the UE is a semi-static PRB bundling configuration; or receiving the configuration information sent through a PDCCH, where the configuration information is sent when the base station determines that the PRB bundling configuration for the UE is a dynamic PRB bundling configuration.

An embodiment of the present disclosure provides an information processing method, which is performed by a UE and may include:
when the PRB bundling configuration is a dynamic PRB bundling configuration, receiving a slot offset, where the slot offset is used to adjust a slot between the PDCCH and a corresponding PDSCH, and a time indicated by the slot offset is greater than a transmission time for transmitting the AI model; and
based on the slot offset, determining whether the received AI model can be used for channel estimation.

Here, if the slot offset is greater than or equal to the transmission time for transmitting the AI model, it is determined that the AI model can be used for channel estimation; or, if the slot offset is less than the transmission time for transmitting the AI model, it is determined that the AI model cannot be used for channel estimation.

An embodiment of the present disclosure provides an information processing method, which is performed by a UE and may include: sending suggestion information, where the suggestion information includes at least one of: computing capability information of the UE, storage capability information of the UE, and channel quality information. The suggestion information is used for the base station to determine an AI model for the UE to perform channel estimation.

An embodiment of the present disclosure provides an information processing method, which is performed by a UE and may include: receiving request information sent by a base station; and sending to the base station the suggestion information determined based on the request information. Here, the request information is used to indicate the UE to send the suggestion information.

For the above implementations, reference may be made to the descriptions regarding the base station side, which will not be described in detail here.

It should be noted that those skilled in the art can understand that the methods provided in the embodiments of the present disclosure may be performed independently, or combined with some methods in other embodiments of the present disclosure or some methods in related technologies.

In order to further explain any embodiment of the present disclosure, a specific embodiment is provided below.

An embodiment of the present disclosure provides an information processing method, which is performed by a communication device. The communication device includes a base station or a UE. The method may include the following steps:

In step S91, model deployment information including an AI model is deployed in the following two methods:

### Method 1: Deploy an AI Model in Advance

The UE sends to the base station at least one of: UE's storage capability information, computing capability information and channel quality information. The base station determines an AI model for at least one number of RBs according to at least one of: the storage capability information of the UE, the computing capability information of the UE and the channel quality information. The base station stores a corresponding relationship between a number of RBs and an AI model as model deployment information, and sends the model deployment information to the UE.

### Method 2: Deploy an AI Model on Demand

When the base station performs a PRB bundling configuration for the UE, the base station queries the model deployment information of the UE. If the base station determines that there is no AI model corresponding to the number of RBs in the model deployment information of the UE, the base station sends an AI model corresponding to the number of RBs to the UE.

For a semi-static PRB bundling configuration, model information may be sent through RRC signaling, where the model information includes an AI model.

For a dynamic PRB bundling configuration, model information may be sent through a PDCCH, where the model information includes an AI model.

In step S92, for the semi-static PRB bundling configuration, the configuration for the channel estimation is as follows:
Case A: the number of RBs in the semi-static PRB bundling configuration is a first type of value, such as “2” or “4”:

The base station determines an AI model corresponding to the configured number of RBs with the same precoding.

The base station sends configuration information through the RRC signaling, and the configuration information includes RB indication information and model indication information. The RB indication information indicates the number of RBs with the same precoding, and the model indication information indicates the AI model corresponding to the number of RBs.

The base station queries the model deployment information of the UE. If it is determined that there is no AI model corresponding to the number of RBs in the model deployment information of the UE, an AI model is sent to the UE through the RRC signaling.

In one embodiment, the configured number of RBs with the same precoding may be: the number of RBs with the same precoding newly configured.
Case B: the number of RBs in the semi-static PRB bundling configuration is a second type of value, such as “wideband”. For Case B, the following two methods may be used:
Method B1: the base station queries the model deployment information of the UE, determines an AI model from the model deployment information, sets the RB indication information to the target number of RBs corresponding to the AI model, and sends the configuration information through the RRC signaling. The configuration information includes the RB indication information and model indication information;
Here, determining the AI model from the model deployment information in method B1 may be: determining the AI model based on at least one of: the storage capability information of the UE, the computing capability information of the UE, and the channel quality information;
Here, method B1 may also be: if the number of RBs in the semi-static PRB bundling configuration is the second type of value, the target number of RBs is determined based on at least one of: the computing capability information of the UE, the storage capability information of the UE, and the channel quality information; the configuration information is sent through the RRC signaling, and the configuration information includes the RB indication information and the model indication information. The RB indication information indicates the target number of RBs, and the model indication information indicates the AI model corresponding to the target number of RBs.
Method B2: the base station sends PRB bundling configuration information to the UE, where the PRB bundling configuration information includes: type information and value information. Based on the type information and value information, the UE determines that the number of RBs in the semi-static PRB bundling configuration of the UE is the second type of value “wideband”. The UE determines the AI model to perform channel estimation based on at least one of: the storage capability information of the UE, the computing capability information of the UE, and the channel quality information.

In step S93, for the dynamic PRB bundling configuration, the configuration for the channel estimation is as follows:
Case C: the number of RBs in the dynamic PRB bundling configuration is the first type of value, such as “2” or “4”:

The base station determines the AI model corresponding to the configured number of RBs with the same precoding.

The base station queries the model deployment information of the UE:
if there is an AI model corresponding to the number of RBs in the model deployment information of the UE, the configuration information is sent through the PDCCH. The configuration information includes: RB indication information and model indication information. The RB indication information indicates the number of RBs with the same precoding, and the model indication information indicates the AI model corresponding to the number of RBs;
if there is no AI model corresponding to the number of RBs in the model deployment information of the UE, the base station queries the transmission time k for transmitting the AI model and sends the AI model to the UE. The base station adjusts a slot offset between the PDCCH and a corresponding PDSCH, the time indicated by the slot offset is greater than k, and sends the RB indication information, the model indication information and the slot offset to the UE through the PDCCH.

Here, the slot offset may be one kind of information in the PRB bundling configuration information.
Case D: the number of RBs in the dynamic PRB bundling configuration is the second type of value, such as “wideband”. For Case D, the following three methods may be used:
Method D1: the base station queries the model deployment information of the UE, determines the AI model from the model deployment information, sets the RB indication information to the target number of RBs corresponding to the AI model, and sends configuration information through the PDCCH. The configuration information includes the RB indication information and the model indication information.

Here, determining the AI model from the model deployment information in method D1 may be: determining the AI model based on at least one of: the storage capability information of the UE, the computing capability information of the UE, and the channel quality information;
Here, method D1 may also be: if the number of RBs in the dynamic PRB bundling configuration is the second type of value, the target number of RBs is determined based on at least one of: the computing capability information of the UE, the storage capability information of the UE, and the channel quality information. The configuration information is sent through PDCCH signaling. The configuration information includes RB indication information and model indication information. The RB indication information indicates the target number of RBs. The model indication information indicates the AI model corresponding to the target number of RBs.
Method D2: the base station sends PRB bundling configuration information to the UE, where the PRB bundling configuration information includes: type information and value information. Based on the type information and value information, the UE determines that the number of RBs in the dynamic PRB bundling configuration of the UE is the second type of value “wideband”. The UE determines the AI model to perform channel estimation based on at least one of: the storage capability information of the UE, the computing capability information of the UE, and the channel quality information.
Method D3: the base station sends a request message; and the UE reports suggestion information based on the request message; where the suggestion information includes at least one of: the computing capability information of the UE, the storage capability information of the UE, and the channel quality information; and the AI model is determined based on the suggestion information.

The base station queries the model deployment information of the UE:
if the AI model exists in the model deployment information of the UE, the configuration information is sent through the PDCCH; where the configuration information includes: RB indication information and model indication information;
if the AI model does not exist in the model deployment information of the UE, the base station queries the transmission time k for transmitting the AI model and sends the AI model to the UE; the base station adjusts the slot offset between the PDCCH and the corresponding PDSCH, where the time indicated by the slot offset is greater than k, and sends the RB indication information, the model indication information and the slot offset to the UE through the PDCCH.

It should be noted that those skilled in the art can understand that the methods provided in the embodiments of the present disclosure may be performed independently, or combined with some methods in other embodiments of the present disclosure or some methods in related technologies.

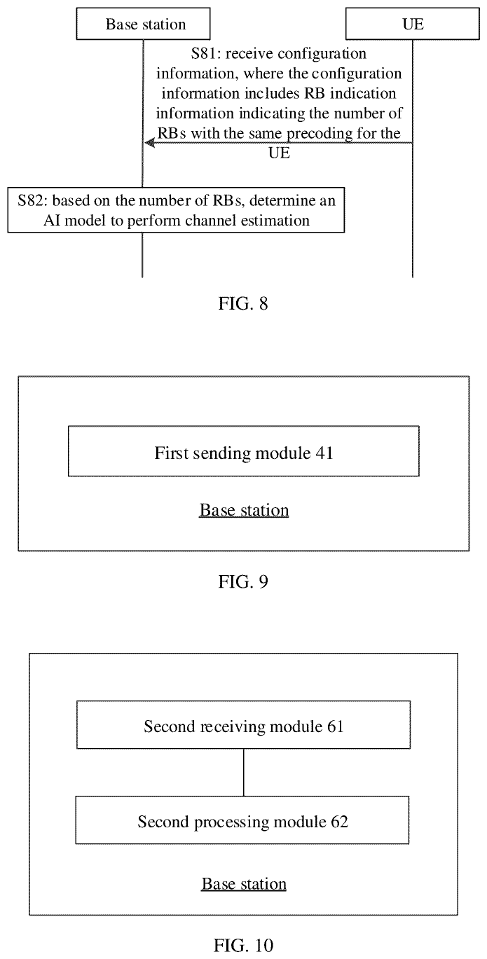

As shown in FIG. 9, an embodiment of the present disclosure provides an information processing apparatus, which is applied to a base station and includes:
a first sending module 41 is configured to send configuration information, where the configuration information includes RB indication information indicating the number of RBs with the same precoding for the UE, and the number of RBs is used for the UE to determine an AI model to perform channel estimation.

An embodiment of the present disclosure provides an information processing apparatus, which is applied to a base station and may include: a first sending module 41 configured to send configuration information; where the configuration information includes RB indication information indicating the target number of RBs with the same precoding for the UE, and the target number of RBs is used for the UE to determine an AI model to perform channel estimation.

In some embodiments, the configuration information includes model indication information indicating an AI model adopted by the UE.

An embodiment of the present disclosure provides an information processing apparatus, which is applied to a base station and may include: a first sending module 41 configured to send configuration information, where the configuration information includes RB indication information and model indication information.

An embodiment of the present disclosure provides an information processing apparatus, which is applied to a base station and may include: a first processing module configured to determine a target number of RBs based on the number of RBs; and based on the target number of RBs, determine an AI model corresponding to the target number of RBs.

An embodiment of the present disclosure provides an information processing apparatus, which is applied to a base station and may include: a first processing module configured to determine a target number of RBs based on the number of RBs in a PRB bundling configuration; and based on the target number of RBs, determine an AI model corresponding to the target number of RBs.

An embodiment of the present disclosure provides an information processing apparatus, which is applied to a base station and may include: a first processing module configured to determine that the target number of RBs is equal to the number of RBs in response to the number of RBs being a first type of value.

An embodiment of the present disclosure provides an information processing apparatus, which is applied to a base station and may include: a first processing module configured to determine that the target number of RBs is equal to the number of RBs in response to the number of RBs in the PRB bundling configuration being a first type of value.

An embodiment of the present disclosure provides an information processing apparatus, which is applied to a base station and may include: a first processing module configured to, in response to the number of RBs being a second type of value, determine the target number of RBs based on at least one of: computing capability information of the UE, storage capability information of the UE, channel quality information, and model deployment information of the UE.

An embodiment of the present disclosure provides an information processing apparatus, which is applied to a base station and may include: a first processing module configured to, in response to the number of RBs in the PRB bundling configuration being a second type of value, determine the target number of RBs based on at least one of: computing capability information of the UE, storage capability information of the UE, channel quality information and model deployment information of the UE.

An embodiment of the present disclosure provides an information processing apparatus, which is applied to a base station and may include: a first sending module 41 configured to send RRC signaling carrying configuration information based on the PRB bundling configuration of the UE being a semi-static PRB bundling configuration.

An embodiment of the present disclosure provides an information processing apparatus, which is applied to a base station and may include: a first sending module 41 configured to send configuration information through a PDCCH based on the PRB bundling configuration of the UE being a dynamic PRB bundling configuration.

An embodiment of the present disclosure provides an information processing apparatus, which is applied to a base station and may include: a first sending module 41 configured to send configuration information including RB indication information and model indication information in response to determining that there is an AI model corresponding to the target number of RBs in the UE based on the model deployment information of the UE.

An embodiment of the present disclosure provides an information processing apparatus, which is applied to a base station and may include: a first sending module 41 configured to send configuration information including at least RB indication information in response to determining that there is no AI model corresponding to the target number of RBs in the UE based on the model deployment information of the UE.

An embodiment of the present disclosure provides an information processing apparatus, which is applied to a base station and may include: a first sending module 41 configured to send model information to the UE in response to determining that there is no AI model corresponding to the target number of RBs in the UE based on the model deployment information of the UE, where the model information includes an AI model corresponding to the target number of RBs.

An embodiment of the present disclosure provides an information processing apparatus, which is applied to a base station and may include:
a first processing module configured to obtain a transmission time for transmitting an AI model in response to the PRB bundling configuration of the UE being a dynamic PRB bundling configuration;
a first sending module 41 configured to send an adjusted slot offset between a PDCCH and a corresponding PDSCH to the UE, wherein the time indicated by the slot offset is greater than the transmission time.

An embodiment of the present disclosure provides an information processing apparatus, which is applied to a base station and may include:
a first receiving module configured to receive suggestion information, where the suggestion information includes at least one of: computing capability information of the UE, storage capability information of the UE, and channel quality information; and
a first processing module configured to determine an AI model for UE to perform channel estimation based on the suggestion information.

As shown in FIG. 10, an embodiment of the present disclosure provides an information processing apparatus, which is applied to a UE and includes:
a second receiving module 61 configured to receive configuration information, where the configuration information includes RB indication information indicating the number of RBs with the same precoding for the UE; and
a second processing module 62 configured to determine an AI model to perform channel estimation based on the number of RBs.

In some embodiments, the configuration information includes model indication information indicating the AI model adopted by the UE.

An embodiment of the present disclosure provides an information processing apparatus, which is applied to a UE and may include: a second processing module 62 configured to determine an AI model to perform channel estimation based on the number of RBs in the PRB bundling configuration.

The present disclosure provides an information processing apparatus, which is applied to a UE and may include: a second processing module 62 configured to determine to perform channel estimation based on an AI model indicated by model indication information corresponding to the number of RBs.

The present disclosure provides an information processing apparatus, which is applied to a UE and may include: a second processing module 62 configured to determine an AI model corresponding to the number of RBs to perform channel estimation in response to the number of RBs being a first type of value.

The present disclosure provides an information processing apparatus, which is applied to a UE and may include: a second processing module 62 configured to determine an AI model corresponding to the number of RBs to perform channel estimation in response to the number of RBs in the PRB bundling configuration being a first type of value.

The present disclosure provides an information processing apparatus, which is applied to a UE and may include: a second processing module 62 configured to, in response to the number of RBs being a second type of value, determine an AI model to perform channel estimation based on at least one of: model deployment information of the UE, computing capability information of the UE, storage capability information of the UE, and the channel quality information.

The present disclosure provides an information processing apparatus, which is applied to a UE and may include: a second processing module 62 configured to, in response to the number of RBs in the PRB bundling configuration being a second type of value, determine an AI model to perform channel estimation based on at least one of: model deployment information of the UE, computing capability information of the UE, storage capability information of the UE, and the channel quality information.

In one embodiment, the number of RBs includes the target number of RBs.

The present disclosure provides an information processing apparatus, which is applied to a UE and may include:
a second receiving module 61 configured to receive model information, where the model information includes an AI model corresponding to the target number of RBs;
a second processing module 62 configured to determine an AI model corresponding to the target number of RBs to perform channel estimation.

An embodiment of the present disclosure provides an information processing apparatus, which is applied to a UE and may include: a second receiving module 61 configured to receive RRC signaling carrying configuration information; where the RRC signaling is sent when the base station determines that the PRB bundling configuration for the UE is a semi-static PRB bundling configuration.

An embodiment of the present disclosure provides an information processing apparatus, which is applied to a UE and may include: a second receiving module 61 configured to receive configuration information sent through a PDCCH, wherein the configuration information is sent when a base station determines that a PRB bundling configuration for the UE is a dynamic PRB bundling configuration.

The present disclosure provides an information processing apparatus, which is applied to a UE and may include:
a second receiving module 61 configured to receive a slot offset when the RPB bundling configuration is a dynamic PRB bundling configuration, wherein the slot offset is to adjust the slot between the PDCCH and a corresponding PDSCH, the time indicated by the slot offset is greater than the transmission time for transmitting the AI model;
a second processing module 62 configured to determine whether the received AI model can be used for channel estimation based on the slot offset.

An embodiment of the present disclosure provides an information processing apparatus, which is applied to a UE and may include: a second sending module configured to send suggestion information, where the suggestion information includes at least one of: computing capability information of the UE, storage capability information of the UE, and channel quality information. The suggestion information is used for the base station to determine an AI model for the UE to perform channel estimation.

It should be noted that those skilled in the art can understand that the apparatuses provided in the embodiments of the present disclosure may be performed independently, or combined with some apparatuses in other embodiments of the present disclosure or some apparatuses in related technologies.

Regarding the apparatuses in the above embodiments, the specific manner in which each module performs operations has been described in detail in the embodiments of the methods, and will not be elaborated here.

An embodiment of the present disclosure provides a communication device, including:
a processor;
a memory configured to store instructions executable by the processor;
where the processor is configured to, when the executable instructions are run, implement the information processing method of any embodiment of the present disclosure.

In one embodiment, the communication device may be a base station or a UE.

The memory may include various types of storage medium, which are non-temporary computer storage medium that can continue to memorize information stored thereon after the user equipment is powered off.

The processor may be connected to the memory via a bus or the like, and may be used to read an executable program stored in the memory, for example, an executable program for implementing steps in at least one of the methods shown in FIG. 2 to FIG. 10.

An embodiment of the present disclosure also provides a computer storage medium storing a computer executable program. When the executable program is executed by a processor, the information processing method of any embodiment of the present disclosure (for example, at least one of the methods shown in FIG. 2 to FIG. 10) is implemented.

Regarding the device or storage medium in the above embodiments, the specific manner in which each module performs the operation(s) has been described in detail in the embodiments of the methods, and will not be elaborated here.

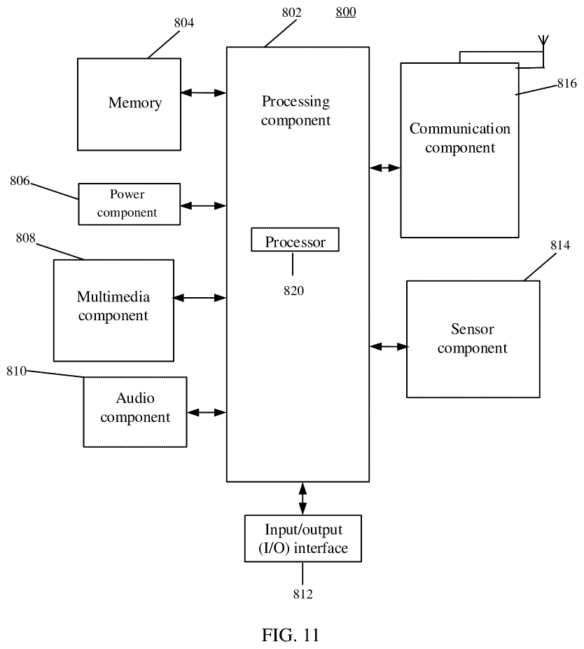

FIG. 11 is a block diagram of a user equipment 800 according to an example embodiment. For example, the user equipment 800 may be a mobile phone, a computer, digital broadcast user equipment, a messaging device, a gaming console, a tablet, a medical device, exercise equipment, a personal digital assistant, and the like.

Referring to FIG. 11, the user equipment 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the user equipment 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the user equipment 800. Examples of such data include instructions for any applications or methods operated on the user equipment 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the user equipment 800. The power component 800 may include a power management system, one or more power sources, and any other components associated with the generation, management, and distribution of power in the user equipment 800.

The multimedia component 808 includes a screen providing an output interface between the user equipment 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the user equipment 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the user equipment 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the user equipment 800. For instance, the sensor component 814 may detect an open/closed status of the user equipment 800, relative positioning of components, e.g., the display and the keypad, of the user equipment 800, a change in position of the user equipment 800 or a component of the user equipment 800, a presence or absence of user contact with the user equipment 800, an orientation or an acceleration/deceleration of the user equipment 800, and a change in temperature of the user equipment 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the user equipment 800 and other devices. The user equipment 800 can access a wireless network based on a communication standard, such as WiFi, 4G, or 5G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the user equipment 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the user equipment 800, for performing the above-described methods. For example, the non-transitory computer-readable storage medium may be a ROM, a Random Access Memory (RAM), a CD-ROM, a magnetic tape, a floppy disc, an optical data storage device, and the like.

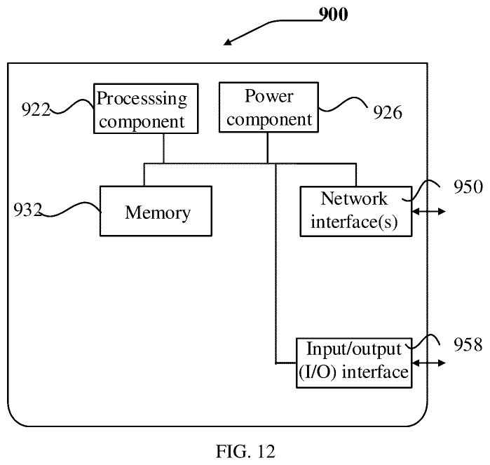

As shown in FIG. 12, an embodiment of the present disclosure shows a structure of a base station. For example, a base station 900 may be provided as a network side device. Referring to FIG. 12, the base station 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the base station.

The base station 900 may also include a power component 926 configured to perform power management of the base station 900, wired or wireless network interface(s) 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. An information processing method, performed by a base station and comprising:
sending configuration information, wherein the configuration information comprises Resource Block (RB) indication information indicating a number of RBs with same precoding for a User Equipment (UE), and the number of RBs is used for the UE to determine an Artificial Intelligence (AI) model to perform channel estimation.

2. The method according to claim 1, further comprising:
based on the number of RBs, determining a target number of RBs; and
based on the target number of RBs, determining the AI model corresponding to the target number of RBs.

3. The method according to claim 2, wherein determining the target number of RBs based on the number of RBs comprises:
in response to the number of RBs being a first type of value, determining that the target number of RBs is equal to the number of RBs; or
in response to the number of RBs being a second type of value, determining the target number of RBs based on at least one of: computing capability information of the UE, storage capability information of the UE, channel quality information, or model deployment information of the UE.

4. The method according to claim 1, wherein the configuration information further comprises: model indication information indicating an AI model adopted by the UE.

5. The method according to claim 2, wherein sending the configuration information comprises:
in response to determining, based on model deployment information of the UE, that an AI model corresponding to the target number of RBs exists in the UE, sending the configuration information comprising the RB indication information and model indication information; or
in response to determining, based on the model deployment information of the UE, that the AI model corresponding to the target number of RBs does not exist in the UE, sending the configuration information comprising at least the RB indication information.

6. The method according to claim 5, further comprising:
in response to determining, based on the model deployment information of the UE, that the AI model corresponding to the target number of RBs does not exist in the UE, sending model information to the UE, wherein the model information comprises the AI model corresponding to the target number of RBs.

7. The method according to claim 6, further comprising:
in response to a Physical Resource Block (PRB) bundling configuration for the UE being a dynamic PRB bundling configuration, obtaining a transmission time for transmitting the AI model; and
adjusting a slot offset between a Physical Downlink Control Channel (PDCCH) and a corresponding Physical Downlink Shared Channel (PDSCH) and sending the slot offset to the UE, wherein a time indicated by the slot offset is greater than the transmission time.

8. The method according to claim 1, wherein sending the configuration information comprises:
in response to a PRB bundling configuration for the UE being a semi-static PRB bundling configuration, sending Radio Resource Control (RRC) signaling carrying the configuration information; or
in response to the PRB bundling configuration for the UE being a dynamic PRB bundling configuration, sending the configuration information through a Physical Downlink Control Channel (PDCCH).

9. The method according to claim 1, further comprising:
receiving suggestion information, wherein the suggestion information comprises at least one of: computing capability information of the UE, storage capability information of the UE, or channel quality information; and
based on the suggestion information, determining the AI model for the UE to perform channel estimation.

10. An information processing method, performed by a User Equipment (UE), and comprising:
receiving configuration information, wherein the configuration information comprises Resource Block (RB) indication information indicating a number of RBs with same precoding for the UE; and
based on the number of RBs, determining an Artificial Intelligence (AI) model to perform channel estimation.

11. The method according to claim 10, wherein the configuration information further comprises model indication information indicating an AI model adopted by the UE;
wherein determining the AI model to perform channel estimation based on the number of RBs comprises:
determining to perform channel estimation based on the AI model indicated by the model indication information corresponding to the number of RBs.

12. The method according to claim 10, wherein determining the AI model to perform channel estimation based on the number of RBs comprises:
in response to the number of RBs being a first type of value, determining an AI model corresponding to the number of RBs to perform channel estimation.

13. The method according to claim 10, wherein determining the AI model to perform channel estimation based on the number of RBs comprises:
in response to the number of RBs being a second type of value, determining an AI model to perform channel estimation based on at least one of: model deployment information of the UE, computing capability information of the UE, storage capability information of the UE, or channel quality information.

14. The method according to claim 10, wherein the number of RBs comprises a target number of RBs, and the method further comprises:
receiving model information, wherein the model information comprises an AI model corresponding to the target number of RBs;
wherein determining the AI model to perform channel estimation based on the number of RBs comprises:
determining the AI model corresponding to the target number of RBs to perform channel estimation.

15. The method according to claim 10, wherein receiving the configuration information comprises:
receiving Radio Resource Control (RRC) signaling carrying the configuration information, wherein the RRC signaling is sent when a base station determines that a Physical Resource Block (PRB) bundling configuration for the UE is a semi-static PRB bundling configuration; or
receiving the configuration information sent through a Physical Downlink Control Channel (PDCCH), wherein the configuration information is sent when the base station determines that the PRB bundling configuration for the UE is a dynamic PRB bundling configuration.

16. The method according to claim 15, further comprising:
when the RPB bundling configuration is the dynamic PRB bundling configuration, receiving a slot offset, wherein the slot offset is used to adjust a slot between the PDCCH and a corresponding Physical Downlink Shared Channel (PDSCH), and a time indicated by the slot offset is greater than a transmission time for transmitting the AI model; and
based on the slot offset, determining whether the received AI model is capable of being used for channel estimation.

17. The method according to claim 10, further comprising:
sending suggestion information, wherein the suggestion information comprises at least one of: computing capability information of the UE, storage capability information of the UE, or channel quality information, and the suggestion information is used for a base station to determine the AI model for the UE to perform channel estimation.

18. (canceled)

19. (canceled)

20. A communication device, comprising:
a processor; and
a memory configured to store instructions executable by the processor;
wherein the processor is configured to:
send configuration information, wherein the configuration information comprises Resource Block (RB) indication information indicating a number of RBs with same precoding for a User Equipment (UE), and the number of RBs is used for the UE to determine an Artificial Intelligence (AI) model to perform channel estimation.

21. A non-transitory computer storage medium storing a computer executable program, wherein when the executable program is executed by a processor, the processor is caused to perform the information processing method according to claim 1.
